(19) United States
(12) Patent Application Publication
(10) Pub. No.: US 2026/0023392 A1
(43) Pub. Date: Jan. 22, 2026

(54) ROUTE PLANNING METHOD, DEVICE, LAWN MOWING ROBOT, AND STORAGE MEDIUM

(71) Applicant: SHENZHEN MAMMOTION INNOVATION CO., LIMITED, Shenzhen (CN)

(72) Inventors: Jidong WEI, Shenzhen (CN); Zijun HE, Shenzhen (CN); Jinfeng HUA, Shenzhen (CN)

(21) Appl. No.: 19/341,599

(22) Filed: Sep. 26, 2025

Related U.S. Application Data
(63) Continuation of application No. PCT/CN2024/083556, filed on Mar. 25, 2024.

(30) Foreign Application Priority Data
Mar. 27, 2023 (CN) 202310339673.9

(51) Int. Cl. G05D 1/644; G05D 1/246; G05D 1/622; G05D 1/661; G05D 105/15

(52) U.S. Cl. CPC G05D 1/644; G05D 1/246; G05D 1/622; G05D 1/661; G05D 2105/15

(57) ABSTRACT

Embodiments of the present disclosure disclose a route planning method, a device, a lawn mowing robot, and a storage medium, including: detecting whether a charging station is located within a preset operation map; when it is detected that the charging station is located within the preset operation map, acquiring first position information of the lawn mowing robot and second position information of the charging station; calculating a movement cost for the lawn mowing robot to move to the charging station in the operation map based on the first position information and the second position information; and planning a movement route for the lawn mowing robot to move to the charging station based on the movement cost.

### CROSS-REFERENCE TO RELATED APPLICATIONS

This application is the continuation of the international Application No. PCT/CN2024/083556, filed on Mar. 25, 2024, which claims the priority of the Chinese patent application filed with the China Patent Office on Mar. 27, 2023, with application number 202310339673.9 and application name “Route Planning Method, Device, Lawn Mowing Robot, and Storage Medium”, the entire disclosures of which are incorporated by reference.

### FIELD OF THE INVENTION

The present disclosure relates generally to the field of lawn mowing robot technology, and specifically discloses a route planning method, device, lawn mowing robot, and storage medium.

### BACKGROUND

Lawn mowing robots are widely used for the maintenance of family lawns and the trimming of large grasslands. Lawn mowing robots integrate technologies such as motion control, multi-sensor fusion, and path planning. To ensure the continuous operation of the lawn mowing robot, it is necessary to switch the lawn mowing robot to a route planning mode after it completes a mowing task or when its battery is low, so that it can automatically return to a charging station for charging.

However, most current route planning solutions are only suitable for a single area and cannot perform return-to-charge in multiple areas. Solutions for multi-area return-to-charge require a charging station to be set up in each work area, and the method of finding a charging station along an edge and burying a wire uses a fixed route, resulting in poor efficiency for returning to charge.

### SUMMARY

Embodiments of the present application provide a route planning method, device, lawn mowing robot, and storage medium, which can control a lawn mowing robot to return to charge across areas and do not require the use of methods of finding a charging station along an edge and burying a wire, thereby improving the efficiency of returning to charge.

In a first aspect, an embodiment of the present disclosure provides a route planning method, which is performed by a lawn mowing robot and comprises:
detecting whether a charging station is located within a preset operation map;
when it is detected that the charging station is located within the preset operation map, acquiring first position information of the lawn mowing robot and second position information of the charging station;
calculating a movement cost for the lawn mowing robot to move to the charging station in the operation map based on the first position information and the second position information; and
planning a movement route for the lawn mowing robot to move to the charging station based on the movement cost.

Optionally, in some embodiments, the calculating the movement cost for the lawn mowing robot to move to the charging station in the operation map based on the first position information and the second position information includes:
detecting whether the lawn mowing robot and the charging station are located in different operation areas on the operation map based on the first position information and the second position information;
when it is detected that the lawn mowing robot and the charging station are located in different operation areas on the operation map, determining the operation areas included in the operation map; converting the determined operation areas into area nodes and constructing movement paths between different area nodes; and
calculating the movement cost for the lawn mowing robot to move to the charging station in the operation map based on the first position information, the area nodes, and the movement paths between different area nodes.

Optionally, in some embodiments, the calculating the movement cost for the lawn mowing robot to move to the charging station in the operation map based on the first position information, the second position information, the area nodes, and the movement paths between different area nodes includes:
identifying path distances corresponding to the movement paths between different area nodes;
determining a movement path corresponding to the lawn mowing robot based on the first position information;
calculating a movement distance for the lawn mowing robot to move to the corresponding movement path; and
calculating the movement cost for the lawn mowing robot to move to the charging station in the operation map based on the second position information, the path distance, and the movement distance.

Optionally, in some embodiments, the method further includes:
when it is detected that the lawn mowing robot and the charging station are located in a same operation area on the operation map, determining the same operation area as a target area;
acquiring a grid map of the target area; and
planning a movement route for the lawn mowing robot to move to the charging station in the grid map based on the first position information, the second position information, and a preset algorithm.

Optionally, in some embodiments, the planning the movement route for the lawn mowing robot to move to the charging station based on the movement cost includes:
creating a first node set corresponding to a shortest route and a second un-traversed node set based on the movement cost;
selecting a node with a minimum movement cost in the second node set and adding it to the first node set to obtain an updated first node set; and
performing a reverse search on a node in the updated first node set to obtain the movement route for the lawn mowing robot to move to the charging station.

Optionally, in some embodiments, the performing the reverse search on the node in the updated first node set to obtain the movement route for the lawn mowing robot to move to the charging station includes:
determining a target node in the updated first node set;
traversing adjacent nodes adjacent to the target node, and determining an adjacent node with a minimum movement cost as a connected node of the target node;
determining the connected node as a reference node, and returning to execute the step of traversing the adjacent nodes adjacent to the target node until a reverse route is output; and
reversing the reverse route to obtain the movement route for the lawn mowing robot to move to the charging station.

Optionally, in some embodiments, the method further includes:
when a blockage is identified in the movement route, determining an area of the blockage as a blocked operation area; and
planning a movement route for the lawn mowing robot to move to the charging station based on a previous operation area of the blocked operation area as a benchmark.

In a second aspect, an embodiment of the present disclosure provides a route planning device, which is applied to a lawn mowing robot and includes:
a detection component, configured to detect whether a charging station is located within a preset operation map;
an acquisition component, configured to acquire first position information of the lawn mowing robot and second position information of the charging station when it is detected that the charging station is located within the preset operation map;
a calculation component, configured to calculate a movement cost for the lawn mowing robot to move to the charging station in the operation map based on the first position information and the second position information; and
a planning component, configured to plan a movement route for the lawn mowing robot to move to the charging station based on the movement cost.

In a third aspect, an embodiment of the present disclosure provides a lawn mowing robot, which includes a memory, a processor, and a computer program stored in the memory and executable on the processor, where the processor executes the program to implement steps of the route planning method described above.

In a fourth aspect, an embodiment of the present application provides a storage medium, having a computer program stored thereon, where the computer program is executed by a processor to implement steps of the route planning method described above.

The present disclosure provides a route planning method, a device, a lawn mowing robot, and a storage medium. The method includes: detecting whether a charging station is located within a preset operation map; when it is detected that the charging station is located within the preset operation map, acquiring first position information of the lawn mowing robot and second position information of the charging station; then, calculating a movement cost for the lawn mowing robot to move to the charging station in the operation map based on the first position information and the second position information; and finally, planning a movement route for the lawn mowing robot to move to the charging station based on the movement cost. The route planning solution provided in the present disclosure can calculate a movement cost for the lawn mowing robot to move to the charging station in the operation map based on the first position information and the second position information, and use the movement cost for route planning, thereby achieving control of the lawn mowing robot to return to charge across areas without the need to find a charging station along an edge or bury a wire, which improves the efficiency of returning to charge.

### BRIEF DESCRIPTION OF THE DRAWINGS

In order to more clearly illustrate the technical solutions in the embodiments of the present disclosure, a brief introduction to the drawings that are needed for describing the embodiments is provided below. It is apparent that the drawings described below are merely some embodiments of the present disclosure, and those skilled in the art can obtain other drawings based on these drawings without creative efforts.

FIG. 1 is a schematic diagram of a scene of a route planning method provided by an embodiment of the present disclosure.

FIG. 2 is a schematic flow chart of a route planning method provided by an embodiment of the present disclosure.

FIG. 3 is a schematic diagram of a jump point search in a route planning method provided by an embodiment of the present disclosure.

FIG. 4 is a directed node graph in a route planning method provided by an embodiment of the present disclosure.

FIG. 5 is a schematic structural diagram of a route planning device provided by an embodiment of the present disclosure.

FIG. 6 is a schematic structural diagram of a calculation component in a route planning device provided by an embodiment of the present disclosure.

FIG. 7 is a schematic structural diagram of a planning component in a route planning device provided by an embodiment of the present disclosure.

FIG. 8 is a schematic structural diagram of an electronic device provided by an embodiment of the present disclosure.

### DETAILED DESCRIPTION OF THE INVENTION

The technical solutions in the embodiments of the present disclosure are clearly and completely described below in conjunction with the drawings in the embodiments of the present disclosure. It is apparent that the described embodiments are only some of the embodiments of the present disclosure, and not all of them. All other embodiments obtained by those skilled in the art based on the embodiments in the present disclosure without making creative efforts fall within the protection scope of the present disclosure.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element. In addition, the connection can be for a fixing purpose or a circuit connection purpose.

It should be understood that the terms “length,” “width,” “upper,” “lower,” “front,” “rear,” “left,” “right,” “vertical,” “horizontal,” “top,” “bottom,” “inside,” “outside,” and the like indicating a direction or a position relationship are based on the direction or position relationship shown in the drawings, are merely for the convenience of describing and simplifying the embodiments of the present invention, and do not indicate or imply that the device or element referred to must have a specific direction or be constructed and operated in a specific direction, and therefore cannot be construed as a limitation on the present invention.

In addition, the terms “first,” “second,” and the like are used for description purposes only and should not be construed as indicating or implying relative importance or implicitly indicating the number of the technical features indicated. Therefore, a feature defined by “first,” “second,” and the like may explicitly or implicitly include one or more of the features. In the description of the embodiments of the present disclosure, the meaning of “a plurality of” is two or more, unless otherwise explicitly and specifically defined.

An embodiment of the present disclosure provides a route planning method, a device, a lawn mowing robot, and a storage medium.

The route planning device can be specifically integrated in a Microcontroller Unit (MCU) of a lawn mowing robot, and can also be integrated in a smart terminal or a server. An MCU, also known as a Single Chip Microcomputer or a single-chip microcomputer, is a chip-level computer that appropriately reduces the frequency and specifications of a Central Processing Unit (CPU) and integrates peripheral interfaces such as a memory, a counter (Timer), Universal Serial Bus (USB), analog-to-digital conversion/digital-to-analog conversion, Universal Asynchronous Receiver/Transmitter (UART), Programmable Logic Controller (PLC), and Direct Memory Access (DMA) to form a combination control for different disclosure scenarios. A lawn mowing robot can automatically travel, prevent collision, automatically return to charge within a range, have safety detection and battery level detection, and have a certain climbing ability, and is especially suitable for lawn trimming and maintenance in family courtyards, public green spaces, and other places. Its features are: automatic mowing, grass debris cleaning, automatic rain avoidance, automatic charging, automatic obstacle avoidance, a compact appearance, an electronic virtual fence, network control, and the like.

The terminal can be a smart phone, a tablet computer, a laptop computer, a desktop computer, a smart speaker, a smart watch, or the like, but is not limited thereto. The terminal and the server can be directly or indirectly connected through a wired or wireless communication manner. The server can be an independent physical server, a server cluster or a distributed system composed of a plurality of physical servers, or a cloud server that provides basic cloud computing services such as cloud services, cloud databases, cloud computing, cloud functions, cloud storage, network services, cloud communication, middleware services, domain name services, security services, Content Delivery Network (CDN), and big data and artificial intelligence platforms. The present disclosure is not limited to this.

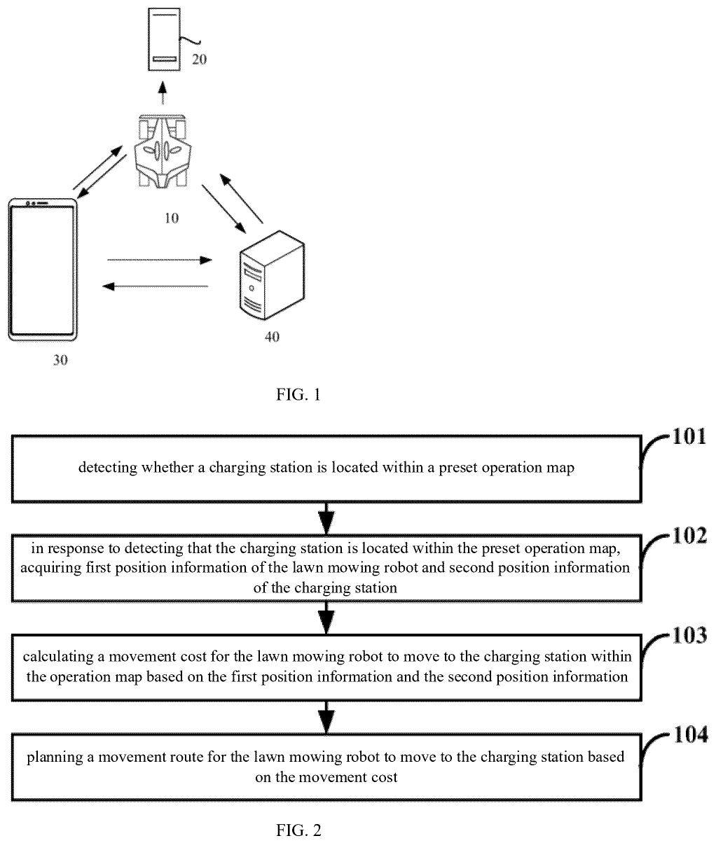

For example, please refer to FIG. 1. The present disclosure provides a lawn mowing system, which includes a lawn mowing robot 10, a charging station 20, a server 30, and a user device 40 that are in a communication connection with each other. For example, a user can control the lawn mowing robot 10 to perform obstacle detection and mowing path planning through the user device 40. When the lawn mowing robot 10 has completed a mowing operation or its battery is low, or when there is a problem that affects the navigation of the lawn mowing robot 10, the server 30 can detect whether the charging station 20 is located within a preset operation map. When the server 30 detects that the lawn mowing robot 10 and the charging station 20 are located within the preset operation map, it acquires first position information of the lawn mowing robot 10 and second position information of the charging station 20. Then, the server 30 calculates a movement cost for the lawn mowing robot 10 to move to the charging station 20 in the operation map based on the first position information and the second position information. Finally, the server 30 plans a movement route for the lawn mowing robot 10 to move to the charging station 20 based on the movement cost.

The following describes them in detail. It should be noted that the description order of the following embodiments is not a limitation on the priority order of the embodiments.

A route planning method includes: detecting whether a charging station is located within a preset operation map; when it is detected that the charging station is located within the preset operation map, acquiring first position information of the lawn mowing robot and second position information of the charging station; calculating a movement cost for the lawn mowing robot to move to the charging station in the operation map based on the first position information and the second position information; and planning a movement route for the lawn mowing robot to move to the charging station based on the movement cost.

Please refer to FIG. 2, which is a schematic flow chart of a route planning method provided by an embodiment of the present disclosure. The specific process of the route planning method can be as follows:

101, Detect whether a charging station is located within a preset operation map.

A user can define at least one operation area (mowing area). In the present disclosure, all operation areas are referred to as an operation map. The operation map can be pre-built. For example, the operation map can include operation area A, operation area B, and operation area C, which are connected to each other through movement paths. Of course, operation area A is connected to operation area B through a movement path al, and operation area B is connected to operation area C through a movement path b. The specific configuration can be set according to an actual situation, and is not described in detail herein.

102, When it is detected that a charging station is located within a preset operation map, acquire first position information of the lawn mowing robot and second position information of the charging station.

The lawn mowing robot and the charging station can be located in a same operation area in the preset operation map, in different operation areas in the preset operation map, or not in the preset operation map (that is, the area where the charging station is located is not divided into the operation map and/or the lawn mowing robot has left the operation area).

It should be noted that when the charging station is not located within the preset operation map, the return-to-charge action is not performed for the safety of the return-to-charge procedure.

When the lawn mowing robot and the charging station are located in a same operation area in the preset operation map, a movement route for the lawn mowing robot to move to the charging station can be planned based on a grid map corresponding to the operation area. That is, optionally, in some embodiments, the method can further include:

(11) when it is detected that the lawn mowing robot and the charging station are located in a same operation area on the operation map, determining the same operation area as a target area;

(12) acquiring a grid map of the target area; and

(13) planning a movement route for the lawn mowing robot to move to the charging station in the grid map based on the first position information, the second position information, and a preset algorithm.

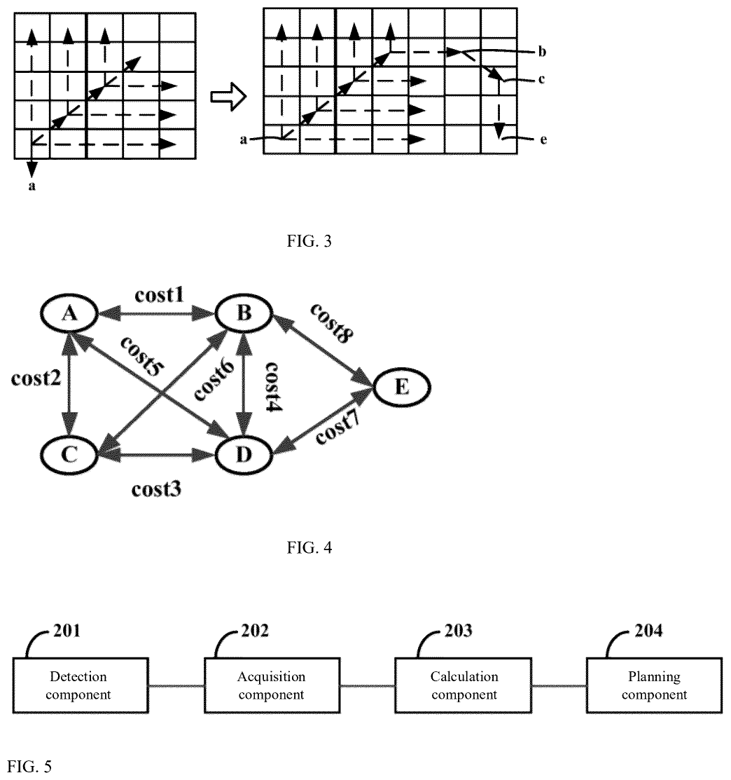

For example, specifically, when it is detected that the lawn mowing robot and the charging station are located in a same operation area on the operation map, the same operation area is determined as a target area. Then, a grid map of the target area can be acquired. Next, a movement route for the lawn mowing robot to move to the charging station is planned in the grid map based on the first position information, the second position information, and a Jump Point Search (JPS) algorithm. The JPS algorithm is actually an improvement of the A* pathfinding algorithm, that is, it proposes a more optimized strategy when expanding a search node. Specifically, please refer to FIG. 3. A current node a first performs horizontal and vertical straight exploration and no key nodes are found. A diagonal exploration is further performed, and the nodes obtained in the first exploration perform horizontal and vertical straight exploration, and no key nodes are found. A diagonal exploration is further executed. When a horizontal straight exploration is executed on the nodes obtained in the third exploration, a key node b is found. It has a forced node c, and a destination e is found. In this way, an obstacle avoidance path is explored to reach the front of the charging station. If an obstacle appears in the area, the JPS algorithm will explore a new obstacle avoidance path through re-planning to reach the front of the charging station again. When the robot reaches the front of the charging station, the infrared signal is more reliable, and it can directly perform reverse-to-charge by using the infrared signal.

It should be noted that a forced node refers to: there are obstacles in eight adjacent nodes of a node X, and a distance cost of a parent node P of X reaching an adjacent node N through X is smaller than a distance cost of any path not through X reaching n, then N is called a forced node of X.

When the lawn mowing robot and the charging station are both located within the preset operation map, and are located in different operation areas in the preset operation map, step 103 is executed.

103, Calculate a movement cost for the lawn mowing robot to move to the charging station in the operation map based on the first position information and the second position information.

When the lawn mowing robot and the charging station are both located within the preset operation map, and are located in different operation areas in the preset operation map, the multi-area operation scenario can be abstracted into a directed node graph. For example, specifically, please refer to FIG. 4, where a node represents an operation area, a directed line segment represents a movement path between areas, and a cost on the directed line segment represents an actual movement distance across the two areas. The farther the two areas are, the greater the movement cost is. That is, optionally, in some embodiments, the step “calculating a movement cost for the lawn mowing robot to move to the charging station in the operation map based on the first position information and the second position information” can specifically include:

(21) detecting whether the lawn mowing robot and the charging station are located in different operation areas on the operation map based on the first position information and the second position information;

(22) when it is detected that the lawn mowing robot and the charging station are located in different operation areas on the operation map, determining the operation areas included in the operation map;

(23) converting the determined operation areas into area nodes and constructing movement paths between different area nodes; and

(24) calculating a movement cost value for the lawn mowing robot to move to the charging station in the operation map based on the first position information, the area nodes, and the movement paths between different area nodes.

Please continue to refer to FIG. 4. Assuming that the lawn mowing robot is in area A and the charging station is in area E, the goal of the lawn mowing robot crossing areas is to find the shortest path from area A to area E to achieve a short return-to-charge time and low energy consumption.

Optionally, in some embodiments, the step “calculating a movement cost for the lawn mowing robot to move to the charging station in the operation map based on the first position information, the area nodes, and the movement paths between different area nodes” can specifically include:

(31) identifying path distances corresponding to the movement paths between different area nodes;

(32) determining a movement path corresponding to the lawn mowing robot based on the first position information;

(33) calculating a movement distance for the lawn mowing robot to move to the corresponding movement path; and

(34) calculating the movement cost for the lawn mowing robot to move to the charging station in the operation map based on the second position information, the path distance, and the movement distance.

Where the movement cost value (Cost) of the movement path equals length of the movement path connecting the two operation areas plus distance of the lawn mowing robot from the current operation area to the movement path node. In addition, in order to avoid excessive pursuit of the shortest path and repeatedly walking the same section of the movement path, which leads to serious wear of the grass and damages the lawn, optionally, the cost value of the movement path is Modified once a section of the movement path is completed, and the cost of repeatedly walking the same path is introduced. In this case, the calculation method of the movement cost value cost is as follows:

The movement cost value (Cost) of the movement path equals length of the movement path connecting the two operation areas plus distance of the lawn mowing robot from the current operation area to the movement path node plus fixed cost of executing the movement path multiplied by number of times the movement path is executed.

It can be understood that the movement cost of the movement route for the lawn mowing robot to move to the charging station in the operation map is the sum of all costs. In order to prevent the lawn mowing robot from traveling along the same route multiple times, which leads to serious wear of the same lawn area, optionally, in some embodiments, when the number of times n that the lawn mowing robot travels along the same path is greater than a preset value, the calculation method of the movement cost value cost is as follows:

$$y ( n ) = y + y * {( 1.03 )}^{2 n - 1}$$

Where y(n) is the movement cost value for traveling along the same path for the nth time, y is the movement cost for the lawn mowing robot to move to the charging station for the first time, y equals length of the movement path connecting the two operation areas plus distance of the lawn mowing robot from the current operation area to the movement path node plus fixed cost of executing the movement path multiplied by number of times the movement path is executed. Optionally, n is a positive integer greater than or equal to 3.

Optionally, when the number of times n that the lawn mowing robot travels along the same path is greater than a preset value, the calculation method of the movement cost value cost is as follows:

$$y ( n ) = y + y * {( 1.03 )}^{2 n - D / 3}$$

Where y(n) is the movement cost value for traveling along the same path for the nth time, y is the movement cost for the lawn mowing robot to move to the charging station for the first time, y equals length of the movement path connecting the two operation areas plus distance of the lawn mowing robot from the current operation area to the movement path node plus fixed cost of executing the movement path multiplied by number of times the movement path is executed. Optionally, n is a positive integer greater than or equal to 3, and D is the time interval for performing the mowing operation, and D is a positive integer greater than or equal to 3.

104, Plan a movement route for the lawn mowing robot to move to the charging station based on the movement cost.

For example, specifically, a movement route for the lawn mowing robot to move to the charging station can be planned based on the movement cost by combining a forward search and a reverse search. The idea of the forward search is: in an open set, if a neighbor node of a current node is updated with a cost, if it is not a neighbor node of the current node, its cost is infinite. A node with the lowest cost in the open set U is put into a closed set S. The unselected nodes are still kept in the open set U. The search is iteratively performed until a target point is found or the open set is traversed. The idea of the negative search is: a process of performing a reverse search from the set obtained from the forward search to obtain a shortest path.

For example, let cost1=1, cost2=2, cost3=3, cost4=4, cost5=5, cost6=6, cost7=7, cost8=8, and cost9=9.

Create a node set S that has been traversed and whose shortest path has been found, and then create a second un-traversed node set U.

Step 1: Since the current position of the lawn mowing robot must be the start point of the shortest path, the node A representing the area where the lawn mowing robot is located is put into the set S, and the costs of the adjacent nodes of the node A are updated in the set U to obtain

$$S = \{ A ( 0 ) \}$$

$$U = \{ B ( 1 ) , C ( 2 ) , D ( 5 ) , E ( ∞ ) \}$$

Note: A(0) means the cost from node A to node A is 0. E(∞) means that node E is not an adjacent node of node A, so there is no need to traverse node E. Therefore, the cost from node A to node E is considered infinite.

Step 2: In the set U obtained in step 1, select a node with the minimum cost and add it to the set S, and then update the costs of the adjacent nodes of the minimum cost node again to obtain

$$S = \{ A ( 0 ) , B ( 1 ) \}$$

$$U = \{ C ( 2 ) , D ( 5 ) , E ( 9 ) \}$$

Step 3: Repeat step 2 to obtain

$$S = \{ A ( 0 ) , B ( 1 ) , C ( 2 ) \}$$

$$U = \{ D ( 5 ) , E ( 9 ) \}$$

Step 4: Repeat step 2 to obtain

$$S = \{ A ( 0 ) , B ( 1 ) , C ( 2 ) , D ( 5 ) \}$$

$$U = \{ E ( 9 ) \}$$

Step 5: Repeat step 2. When the target node E is found or the set U is empty, the forward exploration process ends.

$$S = \{ A ( 0 ) , B ( 1 ) , C ( 2 ) , D ( 5 ) , E ( 9 ) \}$$

$$U = \{ \}$$

It should be noted that this example is a special case where the set U happens to be empty when the target node E is found. In a general case, when the set U is empty and the target node E has not been traversed, it means that no feasible path is found. When the set U is not empty but the target node E has been traversed, it means that a feasible path is found in advance.

(2) Perform a reverse search from the set S to obtain a shortest path.

After the forward search, the set is obtained:

$$S = \{ A ( 0 ) , B ( 1 ) , C ( 2 ) , D ( 5 ) , E ( 9 ) \}$$

The exploration starts from the target node E, and the node with the minimum cost among the adjacent nodes of this node is taken as the next exploration node.

Step 1: Take node E as the first point of the shortest path, and traverse the adjacent nodes B and D of node E.

Step 2: Compare the costs of node B and node D, take the node B with a smaller node cost as the second point of the shortest path, and traverse the adjacent nodes A, C, and D of node B.

Step 3: Compare the costs of node A, node C, and node D, take the node A with a smaller node cost as the third point of the shortest path. At this point, node A is the start node of the lawn mowing robot, the reverse traversal ends, and the reverse shortest path E->B->A is obtained.

Step 4: Reverse the reverse shortest path E->B->A to obtain the forward shortest path A->B->E.

Optionally, in some embodiments, the step “planning a movement route for the lawn mowing robot to move to the charging station based on the movement cost” can specifically include:

(41) creating a first node set corresponding to a shortest route and a second un-traversed node set based on the movement cost;

(42) selecting a node with a minimum movement cost in the second node set and adding it to the first node set to obtain an updated first node set; and

(43) performing a reverse search on a node in the updated first node set to obtain the movement route for the lawn mowing robot to move to the charging station.

Optionally, in some embodiments, the step “performing a reverse search on a node in the updated first node set to obtain the movement route for the lawn mowing robot to move to the charging station” can specifically include:

(51) determining a target node in the updated first node set;

(52) traversing adjacent nodes adjacent to the target node, and determining an adjacent node with a minimum movement cost as a connected node of the target node;

(53) determining the connected node as a reference node, and returning to execute the step of traversing the adjacent nodes adjacent to the target node until a reverse route is output; and

(54) reversing the reverse route to obtain the movement route for the lawn mowing robot to move to the charging station.

It should be noted that when the movement path or the area to reach the start point of the movement path is blocked during movement, the cost between the two nodes is set to infinity, and the lawn mowing robot returns to the previous area and re-performs the above algorithm to find a new path. Since the cost of the blocked movement path is set to infinity, it is equivalent to being disconnected, so the movement path cannot be searched again. The new sub-optimal path is an optimal path explored based on the previous area of the blocked area. That is, optionally, the route planning method provided in the present disclosure can further include:

(61) when a blockage is identified in the movement route, determining an area of the blockage as a blocked operation area; and

(62) planning a movement route for the lawn mowing robot to move to the charging station based on a previous operation area of the blocked operation area as a benchmark.

The route planning process of the present disclosure is completed above.

As can be seen from the above, the route planning method provided by the embodiments of the present disclosure can detect whether the lawn mowing robot and the charging station are located within a preset operation map. When it is detected that the lawn mowing robot and the charging station are located within the preset operation map, it acquires first position information of the lawn mowing robot and second position information of the charging station. Then, it calculates a movement cost for the lawn mowing robot to move to the charging station in the operation map based on the first position information and the second position information. Finally, it plans a movement route for the lawn mowing robot to move to the charging station based on the movement cost. The route planning solution provided by the present disclosure can calculate a movement cost for the lawn mowing robot to move to the charging station in the operation map based on the first position information and the second position information, and use the movement cost for route planning, thereby achieving control of the lawn mowing robot to return to charge across areas without the need to find a charging station along an edge or bury a wire, which improves the efficiency of returning to charge.

To facilitate better implementation of the route planning method of the embodiments of the present disclosure, the embodiments of the present disclosure also provide a route planning device based on the above. The meanings of the terms are the same as in the above route planning method, and the specific implementation details can be referred to the descriptions in the method embodiments.

Please refer to FIG. 5, which is a schematic structural diagram of a route planning device provided by an embodiment of the present disclosure. The route planning device can include:
a detection component 201, configured to detect whether a charging station is located within a preset operation map.

A user can define at least one operation area (mowing area). In the present disclosure, all operation areas are referred to as an operation map. The operation map can be pre-built. For details, please refer to the previous embodiments, which are not described in detail herein.
an acquisition component 202, configured to acquire first position information of the lawn mowing robot and second position information of the charging station when it is detected that the charging station is located within the preset operation map.

The lawn mowing robot and the charging station can be located in a same operation area in the preset operation map, in different operation areas in the preset operation map, or not in the preset operation map (that is, the area where the charging station is located is not divided into the operation map and/or the lawn mowing robot has left the operation area).
a calculation component 203, configured to calculate a movement cost for the lawn mowing robot to move to the charging station in the operation map based on the first position information and the second position information.

When the lawn mowing robot and the charging station are both located within the preset operation map and are located in different operation areas in the preset operation map, the multi-area operation scenario can be abstracted into a directed node graph. For details, please refer to the previous embodiments, which are not described in detail herein.

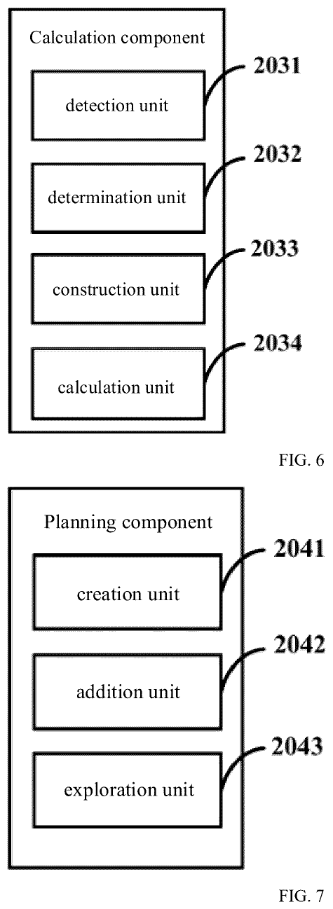

Optionally, in some embodiments, please refer to FIG. 6. The calculation component 203 of the present disclosure can specifically include:
a detection unit 2031, configured to detect whether the lawn mowing robot and the charging station are located in different operation areas on the operation map based on the first position information and the second position information;
a determination unit 2032, configured to determine the operation areas included in the operation map when it is detected that the lawn mowing robot and the charging station are located in different operation areas on the operation map;
a construction unit 2033, configured to convert the determined operation areas into area nodes and construct movement paths between different area nodes; and
a calculation unit 2034, configured to calculate a movement cost value for the lawn mowing robot to move to the charging station in the operation map based on the first position information, the area nodes, and the movement paths between different area nodes.

Optionally, in some embodiments, the calculation unit 2034 is specifically configured to: identify path distances corresponding to the movement paths between different area nodes; determine a movement path corresponding to the lawn mowing robot based on the first position information; calculate a movement distance for the lawn mowing robot to move to the corresponding movement path; and calculate the movement cost for the lawn mowing robot to move to the charging station in the operation map based on the second position information, the path distance, and the movement distance.
a planning component 204, configured to plan a movement route for the lawn mowing robot to move to the charging station based on the movement cost.

Optionally, in some embodiments, please refer to FIG. 7. The planning component 204 of the present disclosure can specifically include:
a creation unit 2041, configured to create a first node set corresponding to a shortest route and a second un-traversed node set based on the movement cost;
an addition unit 2042, configured to select a node with a minimum movement cost in the second node set and add it to the first node set to obtain an updated first node set; and
an exploration unit 2043, configured to perform a reverse search on a node in the updated first node set to obtain the movement route for the lawn mowing robot to move to the charging station.

Optionally, in some embodiments, the exploration unit 2043 is specifically configured to: determine a target node in the updated first node set; traverse adjacent nodes adjacent to the target node, and determine an adjacent node with a minimum movement cost as a connected node of the target node; determine the connected node as a reference node, and return to execute the step of traversing the adjacent nodes adjacent to the target node until a reverse route is output; and reverse the reverse route to obtain the movement route for the lawn mowing robot to move to the charging station.

The route planning process of the present disclosure is completed above.

As can be seen from the above, in the route planning device provided by the present disclosure, the detection component 201 can detect whether a charging station is located within a preset operation map. The acquisition component 202, when it is detected that the charging station is located within the preset operation map, acquires first position information of the lawn mowing robot and second position information of the charging station. Then, the calculation component 203 calculates a movement cost for the lawn mowing robot to move to the charging station in the operation map based on the first position information and the second position information. Finally, the planning component 204 plans a movement route for the lawn mowing robot to move to the charging station based on the movement cost. The route planning solution provided by the present disclosure can calculate a movement cost for the lawn mowing robot to move to the charging station in the operation map based on the first position information and the second position information, and use the movement cost for route planning, thereby achieving control of the lawn mowing robot to return to charge across areas without the need to find a charging station along an edge or bury a wire, which improves the efficiency of returning to charge.

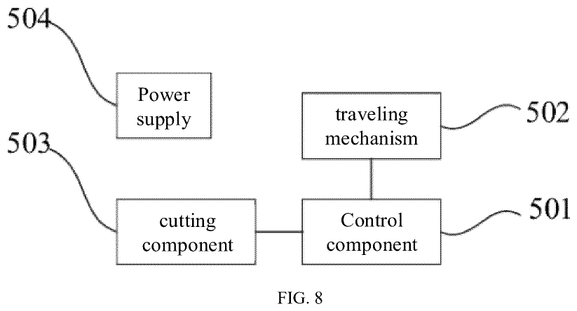

In addition, an embodiment of the present disclosure also provides a lawn mowing robot, as shown in FIG. 8, which shows a schematic structural diagram of the lawn mowing robot involved in the embodiment of the present disclosure. Specifically:

The lawn mowing robot can include a control component 501, a traveling mechanism 502, a cutting component 503, a power supply 504, and other components. Those skilled in the art can understand that the structure of the electronic device shown in FIG. 8 does not constitute a limitation on the electronic device, and can include more or fewer components than shown, or a combination of some components, or different component arrangements. Wherein:
the control component 501 is a control center of the lawn mowing robot. The control component 501 can specifically include components such as a Central Processing Unit (CPU), a memory, an input/output port, a system bus, a timer/counter, an analog-to-digital converter, and a digital-to-analog converter. The CPU executes various functions and processes data of the lawn mowing robot by running or executing software programs and/or components stored in the memory and calling data stored in the memory. Preferably, the CPU can integrate an disclosure processor and a modem processor, where the disclosure processor mainly processes an operating system and disclosure programs, etc., and the modem processor mainly processes wireless communication. It can be understood that the modem processor may not be integrated into the CPU.

The memory can be used to store software programs and modules. The CPU executes various function disclosures and data processing by running the software programs and components stored in the memory. The memory can mainly include a program storage area and a data storage area, where the program storage area can store an operating system, disclosure programs required for at least one function (such as sound playback function, image playback function, etc.), and the like; the data storage area can store data created according to the use of the electronic device, and the like. In addition, the memory can include a high-speed random access memory, and can also include a non-volatile memory, such as at least one disk storage device, a flash memory device, or other volatile solid-state storage devices. Accordingly, the memory can also include a memory controller to provide the CPU with access to the memory.

The traveling mechanism 502 is electrically connected to the control component 501 and is used for adjusting a traveling speed and a traveling direction of the lawn mowing robot in response to a control signal transmitted by the control component 501 to realize a self-movement function of the lawn mowing robot.

The cutting component 503 is electrically connected to the control component 501 and is used for adjusting a height and a rotation speed of a cutting blade in response to a control signal transmitted by the control component to realize a mowing operation.

The power supply 504 can be logically connected to the control component 501 through a power management system to realize functions such as charging management, discharging management, and power consumption management through the power management system. The power supply 504 can also include any component such as one or more Direct Current (DC) or Alternating Current (AC) power supplies, a recharging system, a power failure detection circuit, a power converter or an inverter, a power status indicator, etc.

Although not shown, the lawn mowing robot can also include a communication component, a sensor component, a prompt component, and the like, which are not described in detail herein.

The communication component is used for receiving and transmitting signals in the process of sending and receiving information, and realizes signal sending and receiving with a user device, a base station, or a server by establishing a communication connection with the user device, the base station, or the server.

The sensor component is used for collecting internal environment information or external environment information, and feeding back the collected environment data to the control component for decision-making to realize accurate positioning and intelligent obstacle avoidance functions of the lawn mowing robot. Optionally, the sensors can include: an ultrasonic sensor, an infrared sensor, a collision sensor, a rain sensor, a LiDAR sensor, an Inertial Measurement Unit (IMU), a wheel speed sensor, an image sensor, a position sensor, and other sensors, which are not limited thereto.

The prompt component is used for prompting a user of a current working state of the lawn mowing robot. In this solution, the prompt component includes but is not limited to an indicator light, a buzzer, and the like. For example, the lawn mowing robot can prompt the user of a current power state, a working state of a motor, a working state of a sensor, etc. through the indicator light. Another example is that when a fault or theft of the lawn mowing robot is detected, an alarm can be prompted through the buzzer.

Specifically, in this embodiment, a processor in the control component 501 will load an executable file corresponding to a process of one or more disclosure programs into the memory according to the following instructions, and the processor runs the disclosure program stored in the memory to realize various functions, as follows:
detecting whether a charging station is located within a preset operation map; when it is detected that the charging station is located within the preset operation map, acquiring first position information of the lawn mowing robot and second position information of the charging station; calculating a movement cost for the lawn mowing robot to move to the charging station in the operation map based on the first position information and the second position information; and planning a movement route for the lawn mowing robot to move to the charging station based on the movement cost.

The specific implementation of each of the above operations can be referred to the previous embodiments, which are not described in detail herein.

The embodiments of the present disclosure can detect whether a charging station is located within a preset operation map. When it is detected that the charging station is located within the preset operation map, it acquires first position information of the lawn mowing robot and second position information of the charging station. Then, it calculates a movement cost for the lawn mowing robot to move to the charging station in the operation map based on the first position information and the second position information. Finally, it plans a movement route for the lawn mowing robot to move to the charging station based on the movement cost. The route planning solution provided by the present disclosure can calculate a movement cost for the lawn mowing robot to move to the charging station in the operation map based on the first position information and the second position information, and use the movement cost for route planning, thereby achieving control of the lawn mowing robot to return to charge across areas without the need to find a charging station along an edge or bury a wire, which improves the efficiency of returning to charge.

Those skilled in the art can understand that all or part of the steps in the various methods of the above embodiments can be completed by instructions, or by controlling related hardware by instructions. The instructions can be stored in a computer-readable storage medium and loaded and executed by a processor.

For this purpose, an embodiment of the present disclosure provides a storage medium, in which a plurality of instructions are stored, and the instructions can be loaded by a processor to execute the steps in any of the route planning methods provided by the embodiments of the present disclosure. For example, the instructions can execute the following steps:
detecting whether a lawn mowing robot and a charging station are located within a preset operation map; when it is detected that the lawn mowing robot and the charging station are located within the preset operation map, acquiring first position information of the lawn mowing robot and second position information of the charging station; calculating a movement cost for the lawn mowing robot to move to the charging station in the operation map based on the first position information and the second position information; and planning a movement route for the lawn mowing robot to move to the charging station based on the movement cost.

The specific implementation of each of the above operations can be referred to the previous embodiments, which are not described in detail herein.

The storage medium can include: a Read Only Memory (ROM), a Random Access Memory (RAM), a disk, an optical disc, or the like.

Since the instructions stored in the storage medium can execute the steps in any of the route planning methods provided by the embodiments of the present disclosure, the beneficial effects that can be achieved by any of the route planning methods provided by the embodiments of the present disclosure can be achieved. For details, please refer to the previous embodiments, which are not described in detail herein.

The route planning method, device, lawn mowing robot, and storage medium provided by the embodiments of the present disclosure have been described in detail above. Specific examples are used herein to explain the principles and implementation methods of the present disclosure. The description of the above embodiments is only for helping to understand the method and its core idea of the present disclosure. At the same time, for those skilled in the art, changes can be made in the specific embodiments and disclosure scope based on the idea of the present disclosure. In summary, the content of this specification should not be construed as a limitation on the present disclosure.

1. A route planning method, performed by a lawn mowing robot, wherein the route planning method comprises:
detecting whether a charging station is located within a preset operation map;
in response to detecting that the charging station is located within the preset operation map, acquiring first position information of the lawn mowing robot and second position information of the charging station;
calculating a movement cost for the lawn mowing robot to move to the charging station within the operation map based on the first position information and the second position information; and
planning a movement route for the lawn mowing robot to move to the charging station based on the movement cost.

2. The route planning method of claim 1, wherein the calculating the movement cost for the lawn mowing robot to move to the charging station in the operation map based on the first position information and the second position information comprises:
detecting whether the lawn mowing robot and the charging station are located in different operation areas on the operation map based on the first position information and the second position information;
in response to detecting that the lawn mowing robot and the charging station are located in different operation areas on the operation map, determining the operation areas included in the operation map;
converting a determined operation areas into area nodes and constructing movement paths between different area nodes; and
calculating the movement cost for the lawn mowing robot to move to the charging station in the operation map based on the first position information, the area nodes, and the movement paths between different area nodes.

3. The route planning method of claim 2, wherein the calculating the movement cost for the lawn mowing robot to move to the charging station within the operation map based on the first position information, the second position information, the area nodes, and the movement paths between different area nodes comprises:
identifying path distances corresponding to the movement paths between different area nodes;
determining a corresponding movement path to the lawn mowing robot based on the first position information;
calculating a movement distance for the lawn mowing robot to move to the corresponding movement path; and
based on the second position information, the path distance, and the movement distance, calculating the movement cost for the lawn mowing robot to move to the charging station in the operation map.

4. The route planning method of claim 2, further comprising:
in response to detecting that the lawn mowing robot and the charging station are located in a same operation area on the operation map, determining the same operation area as a target area;
obtaining a grid map of the target area; and
planning the movement route for the lawn mowing robot to move to the charging station in the grid map based on the first position information, the second position information, and a preset algorithm.

5. The route planning method of claim 1, wherein the planning the movement route for the lawn mowing robot to move to the charging station based on the movement cost comprises:
creating a first node set corresponding to a shortest route and a second un-traversed node set based on the movement cost;
selecting a minimum movement cost node in the second node set and adding it to the first node set to obtain an updated first node set; and
performing a reverse search on nodes in the updated first node set to obtain the movement route for the lawn mowing robot to move to the charging station.

6. The route planning method of claim 5, wherein the performing the reverse search on the nodes in the updated first node set to obtain the movement route for the lawn mowing robot to move to the charging station comprises:
determining a target node in the updated first node set;
traversing adjacent nodes adjacent to the target node, and determining a minimum movement cost adjacent node as a connected node of the target node;
determining the connected node as a reference node, and returning to execute the step of traversing the adjacent nodes adjacent to the target node until a reverse route is generated; and
reversing the reverse route to obtain the movement route for the lawn mowing robot to move to the charging station.

7. The route planning method of claim 6, further comprising:
in response to identifying a blockage in the movement route, determining an area of the blockage as a blocked operation area; and
planning the movement route for the lawn mowing robot to move to the charging station based on a previous operation area of the blocked operation area as a reference.

8. The route planning method of claim 1, further comprising:
controlling the lawn mowing robot to execute the movement route; and
modifying a movement cost value of at least a segment of a movement path of the movement route to avoid the lawn mowing robot from repeatedly traveling along a same movement route.

9. The route planning method of claim 1, wherein the calculating the movement cost for the lawn mowing robot to move to the charging station in the operation map based on the first position information and the second position information further comprises:
wherein a cost value of the movement route is equal to a sum of all movement path cost values; and
based on a determination that a number of times n that the lawn mowing robot travels along a same movement path is greater than a preset value, adjusting the movement path cost value to:
$$y ( n ) = y + y * {( 1.03 )}^{2 n - 1}$$
wherein n is a positive integer greater than or equal to 3.

10. The route planning method of claim 1, wherein the calculating the movement cost for the lawn mowing robot to move to the charging station in the operation map based on the first position information and the second position information further comprises:
wherein a cost value of the movement route is equal to a sum of all movement path cost values; and
based on a determination that a number of times n that the lawn mowing robot travels along a same movement path is greater than a preset value and a time interval D for the lawn mowing robot to perform a mowing operation, adjusting the movement path cost value to:
$$y ( n ) = y + y * {( 1.03 )}^{2 n - D / 3}$$
wherein n is a positive integer greater than or equal to 3, and D is a positive integer greater than or equal to 3.

11. A route planning device, applied to a lawn mowing robot, wherein the device comprises:
a detection component, configured to detect whether a charging station is located within a preset operation map;
an acquisition component, configured to acquire first position information of the lawn mowing robot and second position information of the charging station based on detecting that the charging station is located within the preset operation map;
a calculation component, configured to calculate a movement cost for the lawn mowing robot to move to the charging station in the operation map based on the first position information and the second position information; and
a planning component, configured to plan a movement route for the lawn mowing robot to move to the charging station based on the movement cost.

12. The route planning device of claim 11, wherein the calculation component further configured to:
detect whether the lawn mowing robot and the charging station are located in different operation areas on the operation map based on the first position information and the second position information;
in response to detecting that the lawn mowing robot and the charging station are located in different operation areas on the operation map, determine the operation areas included in the operation map;
convert a determined operation areas into area nodes and construct movement paths between different area nodes; and
calculate the movement cost for the lawn mowing robot to move to the charging station in the operation map based on the first position information, the area nodes, and the movement paths between different area nodes.

13. The route planning device of claim 12, wherein the calculation component further configured to:
identify path distances corresponding to the movement paths between different area nodes;
determine a corresponding movement path to the lawn mowing robot based on the first position information;
calculate a movement distance for the lawn mowing robot to move to the corresponding movement path; and
calculate the movement cost for the lawn mowing robot to move to the charging station in the operation map based on the second position information, the path distance, and the movement distance.

14. The route planning device of claim 12, wherein the calculation component further configured to:
in response to detecting that the lawn mowing robot and the charging station are located in a same operation area on the operation map, determine the same operation area as a target area;
obtain a grid map of the target area; and
plan the movement route for the lawn mowing robot to move to the charging station in the grid map based on the first position information, the second position information, and a preset algorithm.

15. The route planning device of claim 11, wherein the planning component further configured to:
create a first node set corresponding to a shortest route and a second un-traversed node set based on the movement cost;
select a minimum movement cost node in the second node set and adding it to the first node set to obtain an updated first node set; and
perform a reverse search on nodes in the updated first node set to obtain the movement route for the lawn mowing robot to move to the charging station.

16. The route planning device of claim 15, wherein the planning component further configured to:
determine a target node in the updated first node set;
traverse adjacent nodes adjacent to the target node, and determining a minimum movement cost adjacent node as a connected node of the target node;
determine the connected node as a reference node, and returning to execute the step of traverse the adjacent nodes adjacent to the target node until a reverse route is generated; and
reverse the reverse route to obtain the movement route for the lawn mowing robot to move to the charging station.

17. The route planning device of claim 16, wherein the planning component further configured to:
in response to identifying a blockage in the movement route, determine an area of the blockage as a blocked operation area; and
plan the movement route for the lawn mowing robot to move to the charging station based on a previous operation area of the blocked operation area as a reference.

18. A storage medium, having a computer program stored thereon, wherein the computer program is executed by a processor to execute operations of a route planning method, wherein the operations comprises:
detecting whether a charging station is located within a preset operation map;
in response to detecting that the charging station is located within the preset operation map, acquiring first position information of the lawn mowing robot and second position information of the charging station;
calculating a movement cost for the lawn mowing robot to move to the charging station within the operation map based on the first position information and the second position information; and
planning a movement route for the lawn mowing robot to move to the charging station based on the movement cost.
